(19) United States
(12) Patent Application Publication
(10) Pub. No.: US 2018/0230822 A1
(43) Pub. Date: Aug. 16, 2018

(54) TITANIUM ALUMINIDE ALLOYS AND TURBINE COMPONENTS

(71) Applicant: GENERAL ELECTRIC COMPANY, Schenectady, NY (US)

(72) Inventors: Stephen Joseph BALSONE, Lebanon, OH (US); Dwight Eric DAVIDSON, Greer, SC (US); Michael Francis Xavier GIGLIOTTI, JR., Niskayuna, NY (US); Pazhayannur Ramanathan SUBRAMANIAN, Schenectady, NY (US); Akane SUZUKI, Ballston Spa, NY (US)

(21) Appl. No.: 15/432,398

(22) Filed: Feb. 14, 2017

(51) Int. Cl. F01D 5/28; C22C 14/00; F01D 5/02

(52) U.S. Cl. CPC F01D 5/28; C22C 14/00; F05D 2300/174; F05D 2220/30; F01D 5/02

(57) ABSTRACT

In some embodiments, a gamma titanium aluminide alloy consists essentially of, in atomic percent, about 38 to about 50% aluminum, about 6% niobium, about 0.25 to about 2% tungsten, optionally up to about 1.5% boron, about 0.01 to about 1.0% carbon, optionally up to about 2% chromium, optionally up to about 2% vanadium, optionally up to about 2% manganese, and the balance titanium and incidental impurities. In some embodiments, the gamma titanium aluminide alloy forms at least a portion of a gas turbine component. In some embodiments, a gamma titanium aluminide alloy, consisting essentially of, in atomic percent, about 40 to about 50% aluminum, about 3 to about 5% niobium, about 0.5 to about 1.5% tungsten, about 0.01 to about 1.5% boron, about 0.01 to about 1.0% carbon, optionally up to about 2% chromium, optionally up to about 2% vanadium, optionally up to about 2% manganese, and the balance titanium and incidental impurities.

### CROSS REFERENCE TO RELATED APPLICATION

This application is related to application Ser. No. ______, Attorney Docket No. 269058 (22113-0177), filed contemporaneously with this application on Feb. 14, 2017, entitled “TITANIUM ALUMINIDE ALLOYS AND TURBINE COMPONENTS” and assigned to the assignee of the present invention, and which is incorporated herein by reference in its entirety.

### FIELD OF THE INVENTION

The present disclosure is directed to titanium aluminide alloys, and in particular, titanium aluminide alloys usable in high temperature gas turbine applications, such as, for example, turbine buckets and turbine wheels.

### BACKGROUND OF THE INVENTION

Industrial gas turbine power output increases with each successive generation of gas turbines. Associated with the turbine power are parameters that determine the power output regime for the gas turbine. One of these parameters is defined in terms of the rotor speed of the turbine and the exit annulus radii for exhaust gases just downstream of the Last Stage Bucket. This parameter is set forth as AN² where N is related to rotor speed and A is related to the exit annulus radii. As AN² grows in area, so do the bucket pull loads. These increasingly greater loads adversely affect the rotor wheel sizes and the stresses that the metal, including the rotating parts, experiences, as well at the volume of metal that is required to be supported.

In recent years, the AN² value has grown sufficiently to warrant the use of costly Alloy 718, a precipitation-hardenable nickel-chrome alloy, also referred to as INCONEL® 718 (Huntington Alloys Corp., Huntington, W. Va.). Nickel-based alloys, such as Alloy 718, are expensive, time consuming to fabricate into turbine components and are relatively dense and heavy, even when fabricated with hollowed out portions so as to permit internal cooling, thereby extending the temperature range of usage. The increased size of gas turbines and the increased weight of the turbines is both limiting further growth of these machines and increasing the cost of fabricating the machines.

### SUMMARY OF THE INVENTION

In an exemplary embodiment, a gamma titanium aluminide alloy consists essentially of, in atomic percent, about 38 to about 50% aluminum (Al), about 1 to about 6% niobium (Nb), about 0.25 to about 2% tungsten (W), optionally up to about 1.5% boron (B), about 0.01 to about 1.0% carbon (C), optionally up to about 2% chromium (Cr), optionally up to about 2% vanadium (V), optionally up to about 2% manganese (Mn), and the balance titanium (Ti) and incidental impurities.

In another exemplary embodiment, a turbine component includes a gamma titanium aluminide alloy consisting essentially of, in atomic percent, about 38 to about 50% Al, about 1 to about 6% Nb, about 0.25 to about 2% W, optionally up to about 1.5% B, about 0.01 to about 1.0% C, optionally up to about 2% Cr, optionally up to about 2% V, optionally up to about 2% Mn, and the balance Ti and incidental impurities.

In another exemplary embodiment, a gamma titanium aluminide alloy consists essentially of, in atomic percent, about 40 to about 50% Al, about 3 to about 5% Nb, about 0.5 to about 1.5% W, about 0.01 to about 1.5% B, about 0.01 to about 1.0% C, optionally up to about 2% Cr, optionally up to about 2% V, optionally up to about 2% Mn, and the balance Ti and incidental impurities.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWING

FIG. 1 schematically depicts a gas turbine with a component including a γ titanium aluminide alloy in an embodiment of the present disclosure.

### DETAILED DESCRIPTION OF THE INVENTION

Provided are exemplary titanium aluminide alloy compositions. Embodiments of the present disclosure, in comparison to compositions not using one or more of the features described herein, have a lower density while withstanding the stresses and creep resistance/stress rupture experienced by the rotor wheels and turbine buckets, are less expensive than superalloy materials conventionally used for turbine components, such as rotor wheels and buckets, have a low density, have improved high temperature properties, have improved high temperature creep resistance, have improved high temperature elongation properties, have improved high temperature oxidation resistance, have improved high temperature ultimate tensile strength, have improved high temperature yield strength, are particularly suitable for use in turbine wheels and turbine buckets as a suitable low cost substitute for nickel-based superalloy systems and highly alloyed steel systems, are characterized by a retained beta (β) phase uniformly distributed in shape and size throughout a γ TiAl matrix, have a high temperature formability at temperatures below about 1365° C. (about 2490° F.), or a combination thereof.

The term “high temperature”, as used herein, refers to a temperature in the range of operating temperatures of a gas turbine. The operating temperature is about 1093° C. (about 2000° F.), alternatively about 1093 to about 1540° C. (about 2000 to about 2800° F.), alternatively about 1093 to about 1200° C. (about 2000 to about 2200° F.), alternatively about 1200° C. (about 2200° F.), alternatively about 1200 to about 1320° C. (about 2200 to about 2400° F.), alternatively about 1320° C. (about 2400° F.), alternatively about 1320 to about 1430° C. (about 2400 to about 2600° F.), alternatively about 1430° C. (about 2600° F.), alternatively about 1430 to about 1540° C. (about 2600 to about 2800° F.), alternatively about 1093° C. (about 2800° F.), alternatively about 1200 to about 1430° C. (about 2200 to about 2600° F.), or any value, range, or sub-range therebetween.

The terms “balance essentially titanium and incidental impurities” and “balance of the alloy essentially titanium”, as used herein, refer to, in addition to titanium, small amounts of impurities and other incidental elements, that are inherent in titanium aluminide alloys, which in character and/or amount do not affect the advantageous aspects of the alloy. Unless otherwise specified, all composition percentages identified herein are atomic percents.

In some embodiments, the compositions are used in high temperature applications, where creep resistance and/or stress rupture resistance is important. In some embodiments, the high temperature application is a gas turbine. In some embodiments, the compositions are used in gas turbine components. In some embodiments, the gas turbine components are buckets or wheels.

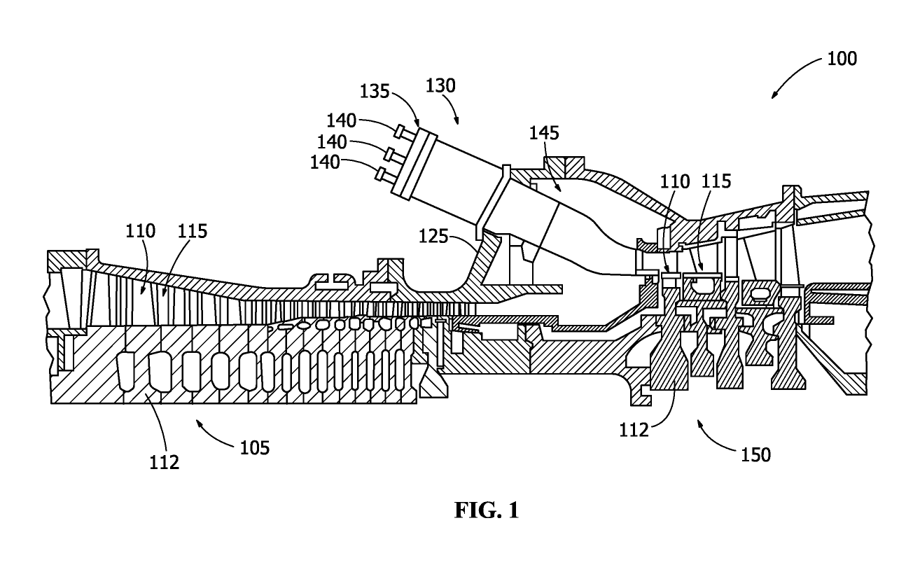

FIG. 1 shows a gas turbine 100 with a compressor section 105, a combustion section 130, and a turbine section 150. The compressor section 105 includes rotating buckets 110 mounted on wheels 112 and non-rotating nozzles 115 structured to compress a fluid. The compressor section 105 may also include a compressor discharge casing 125. The combustion section 130 includes combustion cans 135, fuel nozzles 140, and transition sections 145. Within each of the combustion cans 135, compressed air is received from the compressor section 105 and mixed with fuel received from a fuel source. The mixture is ignited and creates a working fluid. The working fluid generally flows downstream from the aft end of the fuel nozzles 140, downstream through the transition section 145, and into the turbine section 150. The turbine section 150 includes rotating buckets 110 mounted on wheels 112 and non-rotating nozzles 115. The turbine section 150 converts the energy of the working fluid to a mechanical torque. At least one of the turbine components includes a γ titanium aluminide alloy composition. In some embodiments, the turbine component is a bucket 110. In some embodiments, the turbine component is a wheel 112.

In some embodiments, the composition is a γ titanium aluminide alloy. In some embodiments, the γ titanium aluminide alloy is an intermetallic alloy. In some embodiments, the γ titanium aluminide alloy includes, in atomic percent, about 38 to about 50% aluminum (Al), about 1 to about 6% niobium (Nb), about 0.25 to about 2.0% tungsten (W), optionally up to about 1.5% boron (B), about 0.01 to about 1% carbon (C), optionally up to about 2% chromium (Cr), optionally up to about 2% vanadium (V), optionally up to about 2% manganese (Mn), and the balance essentially titanium (Ti) and incidental impurities.

These γ TiAl alloys preferably provide the advantage of low density, allowing them to be used particularly in applications, such as turbine nozzles 115, turbine buckets 110, and turbine wheels 112. These γ TiAl alloys preferably have such a density advantage over currently used materials, specifically nickel-based superalloys and highly alloyed steels, that they may be used without the need to remove metal, such as by hollowing.

The γ TiAl alloys provide a significant cost advantage over nickel-based superalloys and highly-alloyed steels. While the γ TiAl alloys preferably include alloying elements, these alloying elements are preferably present in low amounts. Further, these alloying elements are, for the most part, not strategic and readily available. The use of the γ TiAl alloys may provide a current savings of about $1 million per turbine stage when substituted for superalloy turbine buckets 110. Since there may be as many as 16 turbine stages in a gas turbine engine, the potential savings resulting from the substitution of γ TiAl alloys for superalloys is considerable.

In some embodiments, a γ titanium alloy composition that may be used in turbine wheels 112 and turbine buckets 110 consists essentially of, in atomic percent, about 38 to about 50% aluminum (Al), about 1 to about 6% niobium (Nb), about 0.25 to about 2.0% tungsten (W), optionally up to about 1.5% boron (B), about 0.01 to about 1% carbon (C), optionally up to about 2% chromium (Cr), optionally up to about 2% vanadium (V), optionally up to about 2% manganese (Mn), and the balance essentially titanium (Ti) and incidental impurities.

In some embodiments, the γ titanium aluminide alloy includes, in atomic percent, about 40 to about 50% aluminum (Al), about 3 to about 5% niobium (Nb), about 0.5 to about 1.5% tungsten (W), about 0.01 to about 1.5% boron (B), about 0.01 to about 1% carbon (C), optionally up to about 2% chromium (Cr), optionally up to about 2% vanadium (V), optionally up to about 2% manganese (Mn), and the balance essentially titanium (Ti) and incidental impurities. In some embodiments, the total non-Al, non-Ti alloy content is in the range of about 4.13 to about 12.13%, in atomic percent.

The Al may be present in an amount, in atomic percent, in the range of about 38 to about 50%, alternatively about 40 to about 50%, alternatively about 45 to about 47%, alternatively about 45.5 to about 46.5%, alternatively about 46%, or any amount, range, or sub-range therebetween.

In this alloy, Nb may be added to improve the oxidation resistance of the alloy. Oxidation resistance is an important property for alloys used in the hot section of a turbine, such as for turbine buckets 110 and vanes that are exposed to hot oxidative gases of combustion during operation. The hot exhaust gases tend to deteriorate the alloys used for these components in these applications. The Nb may be added in an amount, in atomic percent, in the range of about 1 to about 6%, alternatively about 1 to about 5%, alternatively about 2 to about 6%, alternatively about 3 to about 5%, alternatively about 3%, or any amount, range, or sub-range therebetween.

Tungsten may be added to form fine stable grains that restrict grain growth during high temperature processing. Tungsten also improves the oxidation resistance and creep rupture resistance of the γ TiAl alloy but may have an adverse effect on ductility and resulting fracture toughness. However, the overall effect of tungsten additions must be balanced by the application. For turbine buckets 110, creep resistance, stress rupture, and oxidation resistance are important properties, and some decrease in ductility may be tolerated for improvements in these properties. For nozzles 115, creep resistance and stress rupture are not important, and sufficient oxidation resistance may be provided by niobium, so that tungsten may be included at or near the low end of the tungsten range. The W may be added in an amount, in atomic percent, in the range of about 0.25 to about 2%, alternatively about 0.5 to about 1.5%, alternatively about 1%, or any amount, range, or sub-range therebetween.

Boron is added to increase high temperature strength and creep resistance of the γ titanium aluminum alloy. The addition of boron forms a fine phase of TiB₂ that restricts grain growth during high temperature processing. Thus boron can be an important addition when the γ TiAl requires high temperature processing, when used in a turbine bucket 110 application, or both. The B may be added in an amount, in atomic percent, up to about 1.5%, alternatively about 0.01 to about 1.5%, alternatively about 0.1%, or any amount, range, or sub-range therebetween.

The addition of carbon in small amounts greatly increases the high temperature creep resistance of γ and γ+β titanium aluminide alloys. Creep resistance is an important property for turbine applications, such as turbine buckets 110, which operate at high temperatures and high rotational speeds. The amount of carbon is carefully controlled as carbon also adversely affects ductility and fracture toughness. Thus, the presence of carbon to provide creep resistance/stress rupture resistance for turbine buckets 110 may be desired, as the buckets 110 operate at high rotational speeds and high temperatures, but may be limited to the low end of the carbon range for turbine nozzles 115, which, although operating at high temperatures, are substantially stationary. The C may be added in an amount, in atomic percent, in the range of about 0.01 to about 1%, alternatively about 0.01 to about 0.1%, alternatively about 0.03%, or any amount, range, or sub-range therebetween.

Chromium is an optional element added in amounts up to 2% to increase the creep resistance/stress rupture properties of the γ TiAl alloy. Creep resistance/stress rupture resistance are desirable properties for turbine buckets 110 that rotate at high speeds in the hot turbine exhaust gases. Creep resistance is not as important in turbine nozzles 115. When present in amounts above about 2%, chromium adversely affects both the toughness and the ductility of the alloy due to the formation of the ordered chromium-rich B-2 phase. The Cr may be added in an amount, in atomic percent, up to about 2%, alternatively about 1 to about 2%, alternatively about 1%, or any amount, range, or sub-range therebetween.

Vanadium is an optional element added in amounts of up to about 2% to improve the toughness of the alloy. Toughness is the ability to absorb energy and plastically deform without fracturing, such as during an impact event from, for example, a foreign object. Toughness is an important property in turbine buckets 110 and nozzles 115. It is a particularly important property for turbine buckets 110 during transient power excursions when the buckets 110 may contact the turbine casing while moving at high speeds. The V may be added in an amount, in atomic percent, up to about 2%, alternatively about 1 to about 2%, alternatively about 1%, or any amount, range, or sub-range therebetween.

Manganese is an optional element added in amounts of up to about 2%. Manganese is included when improved fracture toughness and higher ductility are desired in the alloy, particularly when added in combination with at least one of vanadium and chromium. The Mn may be added in an amount, in atomic percent, up to about 2%, alternatively about 1 to about 2%, alternatively about 1%, or any amount, range, or sub-range therebetween.

Molybdenum (Mo) is preferably specifically excluded in the formulation of the present alloy. Molybdenum provides ductility and toughness at lower temperatures. Molybdenum also promotes dissolution of the β phase during elevated temperature extrusion to provide a finer distribution of β phase within the matrix after extrusion. However, the present alloy is designed for use in turbine buckets 110 and nozzles 115 which only operate at high temperatures. While there may be benefits to adding this dense refractory element for certain applications, there is little benefit from the inclusion of molybdenum for these intended applications, because of the high temperatures of operation of turbine buckets 110 and nozzles 115.

Tantalum (Ta) is preferably specifically excluded in the formulation of the present alloy.

Decreasing the Al content of the alloy below about 50% increases the amount of a second beta (β) phase that is formed in the alloy at high temperatures. The β phase can be further stabilized by the addition of β stabilizers. As noted above, V, Nb, Mo, Ta, Cr, iron (Fe), and silicon (Si) are all β stabilizers. Ta is not used in this alloy both because of its expense as a strategic alloy and its density. Fe is not used in this alloy because of its density. V, Nb, and Mo are isomorphic β stabilizers that stabilize the β phase to lower temperatures. Cr is a eutectoid β stabilizer that can lower the stabilization temperature of the β phase to room temperature, when Cr is present in sufficient concentrations.

The amount of β phase present in the γ+β titanium aluminide alloy at high temperatures is preferably controlled by careful composition control as set forth above, and the β stabilizers may maintain the β phase to lower temperatures. This is an important feature, as the ease of hot working is improved by increasing the amount of β phase that may be present. Thus, forging and hot extruding at higher strain rate may be accomplished with a greater amount of β phase. Of course, the amount of phase that is maintained must be balanced by other properties, which may include, but are not limited to, creep resistance, ultimate tensile strength, yield strength, elongation, toughness, density, and cost. Increasing the concentration of Ti increases the cost of the alloy as well as the density. Thus, it is desirable to balance the properties of the alloy with the cost, Al being much less dense and much less expensive than Ti.

One hot working process that attempts to maintain the work piece at its maximum elevated temperature throughout the entire operation is isothermal forging. Alloys, such as the present titanium aluminide alloys, that inherently have low forgeability may be difficult to form, and their mechanical properties may vary greatly over small temperature ranges. Isothermal forging may be used to help overcome these properties, when alloying additions, such as described above, are included. Isothermal forging is achieved by heating the die to the temperature of, or slightly below the temperature of, the starting work piece. For example, the die may be preheated prior to forging and maintained at temperature by an outside source of heat, such as quartz lamps, or the die may include controlled heating elements which maintain temperature at a preset level. As forces exerted by the die form the work piece, cooling of the work piece between the mold work interface is eliminated or at least substantially reduced, and thus flow characteristics of the metal are greatly improved. Isothermal forging may or may not be performed in a vacuum or controlled atmosphere. Equipment costs for this manufacturing process are high, and the added expense of this type of operation should be justified on a case by case basis.

In order to perform in gas turbine applications in which the alloys are used as turbine wheels 112 or as turbine buckets 110 attached to turbine wheels 112, the alloys must exhibit high temperature creep resistance as well as satisfactory high temperature ultimate tensile strength (UTS), yield strength (YS) and elongation. The alloys disclosed herein may also be used as seals in turbine applications. Since seals are stationary, high temperature creep resistance is not as important, but the alloy must exhibit high temperature ultimate tensile strength (UTS), yield strength (YS) and elongation.

In some embodiments, the amounts of Al, Nb, W, B, C, Cr, V, Mn, and Ti are selected to provide a predetermined amount of at least one property to the γ titanium aluminide alloy. In some embodiments, the at least one property is materials cost, density, high temperature creep resistance, high temperature elongation, high temperature oxidation resistance, high temperature ultimate tensile strength, high temperature yield strength, or a combination thereof.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A gamma titanium aluminide alloy consisting essentially of, in atomic percent:
about 38 to about 50% aluminum (Al);
about 1 to about 6% niobium (Nb);
about 0.25 to about 2% tungsten (W);
optionally up to about 1.5% boron (B);
about 0.01 to about 1.0% carbon (C);
optionally up to about 2% chromium (Cr);
optionally up to about 2% vanadium (V);
optionally up to about 2% manganese (Mn); and
the balance titanium (Ti) and incidental impurities.

2. The gamma titanium aluminide alloy of claim 1, wherein the gamma titanium aluminide alloy has an absence of molybdenum (Mo) and an absence of tantalum (Ta).

3. The gamma titanium aluminide alloy of claim 1, wherein the Cr is present at about 1 to about 2%, in atomic percent.

4. The gamma titanium aluminide alloy of claim 1, wherein the Mn is present at about 1 to about 2%, in atomic percent.

5. The gamma titanium aluminide alloy of claim 1, wherein the V is present at about 1 to about 2%, in atomic percent.

6. The gamma titanium aluminide alloy of claim 1, wherein the Al is present at about 45.5 to about 46.5%, the Nb is present at about 3 to about 5%, and the W is present at about 0.5 to about 1.5%, in atomic percent.

7. The gamma titanium aluminide alloy of claim 1, wherein the Al is present at about 45 to about 47% and the Nb is present at about 5%, in atomic percent.

8. The gamma titanium aluminide alloy of claim 1, wherein the W is present at about 1%, in atomic percent.

9. The gamma titanium aluminide alloy of claim 1, wherein the Nb is present at about 3%, in atomic percent.

10. The gamma titanium aluminide alloy of claim 1, wherein the B is present at about 0.1%, in atomic percent.

11. The gamma titanium aluminide alloy of claim 1, wherein the C is present at about 0.01 to about 0.1%, in atomic percent.

12. The gamma titanium aluminide alloy of claim 1, wherein the Al is present at about 40 to about 50%, in atomic percent.

13. A turbine component comprising a gamma titanium aluminide alloy consisting essentially of, in atomic percent:
about 38 to about 50% aluminum (Al);
about 1 to about 6% niobium (Nb);
about 0.25 to about 2% tungsten (W);
optionally up to about 1.5% boron (B);
about 0.01 to about 1.0% carbon (C);
optionally up to about 2% chromium (Cr);
optionally up to about 2% vanadium (V);
optionally up to about 2% manganese (Mn); and
the balance titanium (Ti) and incidental impurities.

14. The turbine component of claim 13, wherein the turbine component is a wheel or a bucket.

15. The turbine component of claim 13, wherein the B is present at about 0.1%, in atomic percent.

16. The turbine component of claim 13, wherein the C is present at about 0.01 to about 0.1%, in atomic percent.

17. A gamma titanium aluminide alloy consisting essentially of, in atomic percent:
about 40 to about 50% aluminum (Al);
about 3 to about 5% niobium (Nb);
about 0.5 to about 1.5% tungsten (W);
about 0.01 to about 1.5% boron (B);
about 0.01 to about 1.0% carbon (C);
optionally up to about 2% chromium (Cr);
optionally up to about 2% vanadium (V);
optionally up to about 2% manganese (Mn); and
the balance titanium (Ti) and incidental impurities.

18. The gamma titanium aluminide alloy of claim 17, wherein the Al is present at about 45 to about 47%, the Nb is present at about 3%, the W is present at about 1%, the B is present at about 0.1%, and the C is present at about 0.03%, in atomic percent.

19. The gamma titanium aluminide alloy of claim 17, wherein the Al is present at about 46%, in atomic percent.

20. The gamma titanium aluminide alloy of claim 17, wherein the Nb, the W, the B, the C, the Cr, the V, and the Mn are present in a total amount of about 4.13 to about 12.13%, in atomic percent.
